(19) United States
(12) Patent Application Publication
(10) Pub. No.: US 2022/0220593 A1
(43) Pub. Date: Jul. 14, 2022

(54) SHEET METAL FOR PRODUCING AN ELECTROMAGNETIC COMPONENT, IN PARTICULAR A STATOR CORE OR ROTOR CORE, AND METHOD FOR PRODUCING AN ELECTROMAGNETIC COMPONENT

(71) Applicant: ThyssenKrupp Steel Europe AG, Duisburg (DE)

(72) Inventors: Tobias LEWE, Münster (DE); Karsten MACHALITZA, Mülheim an der Ruhr (DE); Volker KAMEN, Herne (DE); Marco TIETZ, Düsseldorf (DE); Florian HERGET, Bochum (DE); Aleksandra BEJM, Dortmund (DE); Dr. rer. nat. Christian WIETHOFF, Marl (DE)

(21) Appl. No.: 17/605,765

(22) PCT Filed: Jan. 17, 2020
(86) PCT No.: PCT/EP2020/051177

§ 371 Date: Oct. 22, 2021

(30) Foreign Application Priority Data
May 20, 2019 (DE) 10 2019 113 291.6

(51) Int. Cl. C22C 38/06; C22C 38/02; C22C 38/04; C09J 163/00; C09J 5/06; C21D 8/12

(52) U.S. Cl. CPC C22C 38/06; C22C 38/02; C21D 8/1277; C09J 163/00; C09J 5/06; C22C 38/04

(57) ABSTRACT

The invention relates to a sheet metal for producing an electromagnetic component, in particular a stator core or a rotor core, wherein the sheet metal is coated with an adhesive covering of a thermally activated adhesive. Said adhesive contains: 60 wt. parts of an epoxy resin in solid resin from, 0.5-15 wt. parts of a latent curing agent, 1-15 weight parts of a latent accelerator. The invention further relates to a method for producing an electromagnetic component.

### BACKGROUND

The subject disclosure relates to a sheet metal for producing an electromagnetic component, in particular a stator core or a rotor core. The subject disclosure also relates to a method for producing an electromagnetic component, in particular a stator core or a rotor core for an electrical machine, in particular for an electric motor.

The mode of operation of electric machines, for example of electric motors, has long been known. The electric motor continues to gain in importance, not least in light of the increasing use of electric motors in individualized passenger transport, often also referred to with the buzzword “electromobility.” Substantial components of every electric motor are a stator and a rotor, the term “stator” denoting a stationary part of the motor and the term “rotor” denoting a moving part of the motor.

One challenge when providing electric motors is to increase the efficiency of the electric motor, for example the provided power per volume and/or the efficiency factor, as part of an economically reasonable effort.

One concept for providing efficient electric motors is the production of stators and/or rotors or of parts of the stators and/or rotors as a so-called stator core or rotor core. In this case, said components are assembled as sheet metal cores, also known as lamella cores, from individual so-called lamellae. The term “lamella” denotes a molded part that has been removed from an electrical steel sheet or electrical steel strip, for example by punching. The lamella cores consist of a large number of thin lamellae which are stacked together and are electrically insulated from one another, either partially or preferably completely. For such purposes, for example, the use of so-called electrical insulating varnishes, which are classified in so-called insulation classes, is known from practice.

The production of such a sheet metal core always comprises the steps of producing lamellae and interconnecting the lamellae. The connection is preferably established in such a way that, after the connection, the lamellae are partially, preferably completely, electrically insulated from one another, which preferably means that two adjacent lamellae are not galvanically interconnected.

The individual lamellae can be produced, for example, by punching. The connection of the punched lamellae to form a sheet metal core can be achieved with a variety of known methods, for example by screwing, by applying clips, by welding or by punch-stacking. However, due to the mechanical action generated during the connection process, each of these production methods known to a person skilled in the art is associated with a negative impact on the electromagnetic properties of the finished sheet metal core that prevail after the connection. In particular, mechanical stresses, which are inevitable in a connection produced according to the prior art, at least to some extent, can have a negative impact on the magnetic properties and the course of magnetic field lines within the sheet metal core, which, for example, directly results in a negative impact on the efficiency of the electric motor produced therefrom. An electrical connection between two or more lamellae, which occurs in some connection processes, for example stamped stacking or welding, results in additional losses.

An expedient option for reducing the negative impact of mechanical effects on the lamellae and at the same time achieving good insulation among the lamellae is to use adhesives as a connecting means. These adhesive systems also have insulating properties similar to electrically insulating varnishes.

A procedure known to a person skilled in the art is the use of so-called baking varnishes. The use of baking varnishes for gluing punched electrical steel sheets is described, for example, in DE 38 29 068 C1. One procedure for using baking varnish is the covering of a sheet metal, in particular a sheet metal strip, the subsequent punching out of individual lamellae from the sheet metal, the aligned positioning of the individual lamellae with respect to one another and the subsequent heat treatment of the resulting sheet stack for a defined period of time and at a defined temperature. In many cases, the lamellae are pressed against one another during the heat treatment, for example by applying a force to the end face, preferably with a uniform surface force, in an axial direction of the sheet metal core, which is directed into the interior of the sheet metal core. Typical reaction temperatures are 150 degrees Celsius to 250 degrees Celsius, and a typical time for the baking varnish to react is 30 to 150 minutes with a subsequent cooling phase, although the exact parameters depend naturally on the specific baking varnish used and the specific geometry present since, for example, a core temperature that is set in the component has an influence on the course of the baking varnish process. Excellent electromagnetic properties of stator cores and/or rotor cores can generally be achieved using this procedure. Due to the time-consuming procedure, however, it is immediately apparent that the use of baking varnishes is not, or at least not optimally, suitable for continuous mass production.

### BRIEF DESCRIPTION

Against the background of the explained configuration, one aspect of the subject disclosure is to create the prerequisites for an efficient production of sheet metal cores, i.e. in particular stator cores or rotor cores, in the machined production environment.

In addition, against the background of the desire for further increased efficiency, aspect to provide electromagnetic components and electrical machines with improved conversion of electromagnetic energy into mechanical energy.

In one aspect of this is achieved with a sheet metal for the production of an electrical component, in particular a stator core or a rotor core.

The term “sheet metal” generally denotes a rolled product made of a metal material and, in addition to a light-gauge metal sheet or a thick-gauge metal sheet, can in particular also denote a metal strip, a metal strip or a metal sheet, for example made of a soft magnetic material, a steel strip or an electrical steel strip. Other methods of manufacturing the sheet metal can optionally be used.

The sheet metal is covered with an adhesive covering of a thermally activated adhesive. The adhesive contains:
60 wt. parts of an epoxy resin based on its solid resin form,
0.5-15 wt. parts of a latent curing agent,
1-15 wt. parts of a latent accelerator.

The adhesive can preferably have 1 to 10 wt. parts of the latent curing agent, particularly preferably 2 to 5 wt. parts of the latent curing agent.

The term “latent curing agent” denotes a substance which is used to cure the epoxy resin, but which has to be activated for curing, in particular by supplying chemical and/or thermal energy. The latent curing agent is added to the adhesive as a solid in powder form, for example.

The term “latent accelerator” denotes a substance which accelerates the curing of the epoxy resin by the latent curing agent. The attribute “latent” in connection with the accelerator relates to the fact that the accelerator must also be activated beforehand by chemical and/or thermal energy in order to fulfill its function. The latent accelerator is added to the adhesive as a solid in powder form, for example.

The above composition relates to the mixture of the components present as solid bodies in the specified wt. parts to form an adhesive mixture which, in dispersion and/or solution with a suitable liquid, becomes the adhesive which can form an adhesive covering. In a usable state, i.e. in a form suitable for covering, the adhesive having the specified components is preferably present as a dispersion of the above composition in a dispersion medium, in particular as an aqueous dispersion.

Since a sheet metal is provided with an adhesive covering made from a thermally activated adhesive, the sheet metal covered with the adhesive can be used as a preliminary product for flexibly adaptable manufacturing processes for electromagnetic components, in particular stator cores or rotor cores. Because the adhesive must first be thermally activated, the adhesive function can be performed at a desired point in time or in a desired method step after the lamellae have been removed from the sheet metal, for example by punching. Within a short period of time after activation, the lamellae must be brought together after activation (optionally preferably also under partial or full-surface pressure in the press and/or in a subsequent compression process) so that they are glued together during the chemical curing reaction. This advantageously creates flawless, non-delaminated and geometrically precise, mechanically stable cores.

In the case of the adhesive composition according to one aspect, the sheet metal has a surface with a short activation time of, for example, 0.5 seconds to 1 second and a short curing time of only a few seconds. These properties go hand in hand with a comparatively high temperature resistance and a comparatively high insulation and aging capacity.

The epoxy resin present in the adhesive that is used according to one aspect comprises one or more epoxy resin components with more than one epoxy group, of which preferably at least one epoxy resin has a softening point greater than 50° Celsius.

The epoxy resins can be aliphatic, cycloaliphatic or aromatic epoxy resins. Aliphatic epoxy resins contain components that carry both an aliphatic group and at least two epoxy resin groups.

Examples of aliphatic epoxy resins can be butanediol diglycidyl ether, hexanediol diglycidyl ether, dimethylpentane dioxide, butadiene dioxide, diethylene glycol diglycidyl ether.

Cycloaliphatic epoxy resins are, for example, 3-cyclohexenylmethyl-3-cyclohexylcarboxylate diepoxide, 3,4-epoxycyclohexylalkyl-3′,4′-epoxycyclohexane carboxylate, 3,4-epoxy-6-methylcyclohexylmethyl-3′,4′-epoxy-o-methylcyclohexane carboxylate, vinylcyclohexane dioxide, Bis(3,4-epoxycyclohexylmethyl)adipate, dicyclopentadiene dioxide, 1,2-epoxy-6-(2,3-epoxypropoxy)hexahydro-4,7-methanoindane.

Aromatic epoxy resins are, for example, bisphenol A epoxy resins, bisphenol F epoxy resins, phenol novolac epoxy resins, cresol novolac epoxy resins, biphenyl epoxy resins, biphenol epoxy resins, 4,4′-biphenoline epoxy resins, divinyl benzene dioxide, 2-glycidyl phenyl glycidyl ether, tetraglycidyl methylene dianiline.

In one embodiment, the epoxy resin is bisphenol A epoxy resin.

The latent curing agent used is a substance or a mixture of substances which preferably enter into curing reactions with the epoxy resins of the adhesive at temperatures in the range of from 80° Celsius to 200° Celsius.

The curing agent can contain dicyandiamides, aziridine derivatives, triazine derivatives, imidazolines, imidazoles, o-tolyl biguanide, cyclic amidines, organic hexafluoroantimonate or hexafluorophosphate compounds or BF3 amine complexes. The compounds can be used individually or in combination.

Examples are 2-methylimidazole, 2-undecylimidazole, 2-heptadecylimidazole, 1,2-dimethylimidazole, 2-ethyl-4-methylimidazole, 2-phenylimidazole, 2-phenyl-4-methylimidazole, 1-benzyl-2-methylimidazole, 1-Benzyl-2-phenylimidazole, 1-cyanoethyl-2-methylimidazole, 1-cyanoethyl-2-undecylimidazole, 1-cyanoethyl-2-ethyl-4-methylimidazole, 1-cyanoethyl-2-phenylimidazole, 1-cyanoethyl-2-undecylimidazolium trimellitate, 1-cyanoethyl-2-phenylimidazolium trimellitate, 2,4-diamino-6-[2′-methylimidazolyl-(1′)]-ethyl-s-triazine, 2,4-diamino-6-[2′-undecylimidazolyl-(1′)]-ethyl-s-triazine, 2,4-diamino-6-[2′-ethyl-4′-methylimidazolyl-(1′)]-ethyl-s-2,4-diamino-6-[2″methylimidazolyl-(1′)]-ethyl-s-triazine, 2-phenylimidazole, 2-phenyl-4,5-dihydroxymethylimidazole, 2-phenyl-4-methyl-5-hydroxymethylimidazole, 2,3-dihydro-1H-pyrrolo [1,2-a] benzimidazole, (1-dodecyl-2-methyl-3-benzyl) imidazolium chloride, 2-methylimidazoline, 2-phenylimidazoline, 2,4-diamino-6-vinyl-1,3,5-triazine, 2,4-diamino-6-vinyl-1,3,5-triazine isocyanic acid adduct, 2,4-diamino-6-methacryloyloxyethyl-1,3,5-triazine, 2,4-diamino-6-methacryloyloxyethyl-1,3,5-triazine isocyanic acid adduct, 1,3,5-triazine, 2,4-diamino-6-methyl-1,3,5-triazine, 2,4-diamino-6-nonyl-1,3,5-triazine, 2,4-diamino-6-phenyl-1,3,5-triazine, 2,4-dimethoxy-6-methyl-1,3,5-triazine, 2,4-dimethoxy-6-phenyl-1,3,5-triazine, 2-amino-4,6-dimethyl-1,3,5-triazine, 2-amino-4-dimethylamino-6-methyl-1,3,5-triazine, 2-amino-4-ethoxy-6-methyl-1,3,5-triazine, 2-amino-4-ethyl-6 methoxy-1,3,5-triazine, 2-amino-4-methoxy-6-methyl-1,3,5-triazine, 2-amino-4-methyl-6-phenyl-1,3,5-triazine, 2-chloro-4,6-dimethoxy-1,3,5-triazine, 2-ethylamino-4-methoxy-6-methyl-1,3,5-triazine, 1-o-tolyl biguanide.

In one embodiment, the accelerator contains a urea derivative and/or an imidazole.

The adhesive composition can also contain further components.

In one embodiment, the curing agent contains a dicyandiamide, an imidazole, a BF3 amine complex, or a combination thereof.

In one embodiment, the adhesive can contain 1 to 10 wt. parts of a latent accelerator, preferably 1 to 5 wt. parts of a latent accelerator, particularly preferably 2 to 5 wt. parts of a latent accelerator, very particularly preferably 2 to 4 wt. parts of a latent accelerator.

In another embodiment, the adhesive furthermore has 0.2 to 8 wt. parts, preferably 0.2 to 4 wt. parts of absorption additive. The absorption additive that can be provided according to this further concept is selected from the group of lamp blacks and/or from the group of water-soluble dyes.

The term absorption additive denotes a substance that absorbs thermal radiation. A substance that absorbs thermal radiation is associated in particular with the advantage of allowing the more efficient use of a method in which the thermal activation of the adhesive takes place by means of electromagnetic radiation, in particular by means of irradiation with light in the IR wavelength range, preferably in the NIR wavelength range.

The adhesive preferably contains one or more of the insulation additives known to a person skilled in the art, and the term “insulation additives” refers to additives specifically provided to increase the electrical resistance of the adhesive. The insulation additives can be contained in the adhesive in amounts of from 1 to 10 wt. parts, preferably 1 to 5 wt. parts.

The latent accelerator contained in the adhesive preferably consists of at least 50 wt. %, more preferably at least 90 wt. %, even more preferably consists completely of urea derivative.

Particularly preferably, the urea derivative is an N,N-dimethylurea or an N,N′-dimethylurea or a bifunctional urea derivative, preferably with two urea groups as functional groups, very particularly preferably a 4,4′-methylene-bis-(phenyldimethylurea), or a mixture of several of the above.

The latent accelerator contained in the adhesive preferably consists of at least 50 wt. %, more preferably at least 90 wt. %, even more preferably at least 98 wt. %, and particularly preferably consists completely of 4,4′-methylene-bis-(phenyldimethylurea).

In an alternative, a urea derivative is used in which at least one, preferably 2, particularly preferably 3, hydrogen atoms are replaced by, independently of one another, alkyl groups and/or phenyl groups, which in turn may be more substituted. The alkyl groups are preferably methyl, ethyl, propyl or butyl, preferably methyl; the phenyl group being phenyl or a deeply substituted find, preferably at position 4, also preferably as a cool 1 of the above-mentioned alkyls. In a further alternative, a difunctional urea derivative is denoted as an above-described derivative which has 2 functional groups. Points your groups are groups of atoms that significantly determine the material properties and, in particular, the reaction behavior of the compound, in particular, against the functional group reactions. Furthermore, the urea derivative can be is halogen-free. In an alternative, the urea derivative has 2 urea derivatives as functional groups. As a result, epoxy resins can advantageously be cured without the presence of dicyanamides as crosslinkers.

In an alternative, an asymmetrically substituted urea is also or exclusively used as the urea derivative.

In a further alternative, a mixture of two, three or more of the aforementioned is used.

A substance can also be provided as a urea derivative

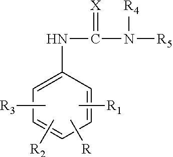

where R: Hydrogen or a group according to

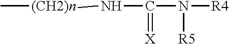

where

n=0 or 1, preferably 1,

X=0 or S, preferably 0,

R1, R2 and R3: each hydrogen, a halogen, nitro group, a substituted or unsubstituted alkyl group, alkoxyl group, aryl group or aryloxyl group,

R4: alkyl group, alkenyl group, cycloalkyl group, cycloalkenyl group, aralkyl group optionally substituted by a halogen, hydroxyl or cyano, preferably methyl, ethyl, propyl, butyl, particularly preferably methyl, R5: like R4 or alkoxyl group, R5 optionally forming a heterocyclic ring with R4, or an N,N-dimethyl-N′-(3,4-dichlorophenyl)urea or an N,N-dimethyl-N′-(3-chloro-4-methylphenyl)urea or an N,N-dimethyl-N′-(3-chloro-4-methoxyphenyl)urea or an N,N-dimethyl-N′(3-chloro-4-ethylphenyl)urea or an N,N-dimethyl-N′-(4-methyl-3-nitrophenyl)urea or an N-(N′-3,4-dichlorophenylcarbamoyl)morpholine or an N,N-dimethyl-N′(3-chloro-4-methylphenyl)thio-urea, the urea derivative is preferably 4,4′-methylene-bis-(phenyldimethylurea);

or a mixture of two, three or more of the aforementioned. Such a mixture preferably contains at least 10%, 25%, preferably 50%, 60%, 70%, 80% or 90% of 4,4′-methylene-bis-(phenyldimethylurea). The advantage of these urea derivatives results from GB 1293142 A; the inventors have found that such derivatives can be used excellently for the production of electromagnetic components.

The urea derivative can also be a mixture of a plurality of the aforementioned urea derivatives.

The mean particle size (arithmetic mean) of the urea derivative is preferably between 1 micrometer and 30 micrometers.

The adhesive covering can be applied to the sheet metal on one or both sides. If an adhesive covering is applied on both sides, the thickness of the covering can be the same, but different thicknesses can also be provided.

The application of the adhesive to the sheet metal can take place by means of known methods, in particular by means of coil coating (roll to roll).

In an exemplary embodiment, the thickness of the adhesive covering, i.e. the thickness of the covering on one side in the case of a one-sided adhesive or the total thickness of the adhesive covering on both sides in the case of a two-sided adhesive covering, is between 1 micrometer and 20 micrometers, preferably between 2 micrometers and 10 micrometers. A total thickness between 4 and 8 micrometers can be particularly preferred.

An adhesive covering of the sheet metal carried out on one side is accompanied by a simpler production in terms of apparatus; an adhesive covering of the sheet metal on both sides is in turn associated with the advantage, that when individual lamellae made of the sheet metal are superimposed, the adhesive surface is positioned on the adhesive surface, which improves adhesion and thus a higher mechanical stability of the electromagnetic component is achieved, which has been shown in tests and is shown below.

The first partial covering of the first sheet metal surface and the second partial covering of the second sheet metal surface with a second thickness are particularly preferably adapted to one another in such a way that the first thickness is at least 1.5 times, preferably twice the second thickness. In such a configuration, the first thickness is responsible for excellent insulation, so that the risk of adhesive gaps is almost negligible, while the thinner of the two, namely the second partial covering applied with the second thickness, substantially serves to produce the excellent adhesion.

A double-sided covering with a total thickness of both coverings between 4 and 6 micrometers is provided according to one exemplary embodiment. Such a small covering thickness is possible with the adhesives used according to the subject disclosure or according to developments of the subject disclosure because of their high reactivity, as the examples produced show. Known baking varnish adhesives usually require a covering thickness greater than 6 micrometers (e.g. baking varnish on both sides, 5 μm on each side). This results in the advantage that components, in particular stators or rotors, can be produced from the sheet metals according to the present disclosure or their developments, which have a significantly higher iron fill factor than components produced by means of the baking varnish method. The advantage is a somewhat higher efficiency of the electrical machine having the component. But adhesive coverings between a total of 1 and 20 micrometers, preferably 2 and 8 micrometers, can be provided.

In a further alternative, an insulating varnish layer is arranged between sheet metal and adhesive layer and/or only insulating varnish is arranged on the side opposite the adhesive layer.

The sheet metal is particularly preferably designed as non-grain-oriented electrical steel strip, also referred to as so-called NO electrical steel, or separated from such, the non-grain-oriented electrical steel strip containing, in addition to Fe and unavoidable impurities, the following elements (all data in wt. %):

0.1-3.50 Si,

0.01-1.60 Al,

0.07-0.65 Mn,

optionally up to 0.25 P.

It goes without saying that the totality of all alloy components and the impurities add up to 100 wt. %. The following conditions can be particularly preferred (all data in wt. %):

2.3-3.40 Si,

0.3-1.1 Al,

0.07-0.250 Mn,

optionally up to 0.030 P, remainder Fe and unavoidable impurities.

It goes without saying that the totality of all alloy components and the impurities add up to 100 wt. %.

The non-grain-oriented electrical steel strip or the non-grain-oriented sheet metal preferably has specific core losses at P1.0; 50 Hz in the range of from 0.7 to 7 W/kg and at P1.5; 50 Hz in the range of from 1.8 to 15 W/kg and/or a polarization at J2500 in the range of from 1.45 T to 1.71 T and at J5000 in the range of from 1.6 T to 1.8 T, determined in accordance with DIN EN 60404-2.

In a specific embodiment, the non-grain-oriented electrical steel strip or the non-grain-oriented sheet metal has specific core losses at P1.0; 50 Hz in the range of from 0.8 to 3.5 W/kg and at P1.5; 50 Hz in the range of from 1.9 to 8.0 W/kg and/or a polarization at J2500 in the range of from 1.47 T to 1.71 T and at J5000 in the range of from 1.58 T to 1.80 T, determined in accordance with DIN EN 60404-2.

In a further specific embodiment, the non-grain-oriented electrical steel strip or the non-grain-oriented sheet metal has specific core losses at P1.0; 50 Hz in the range of from 1.0 to 1.5 W/kg and at P1.5; 50 Hz in the range of from 2.2 to 3.3 W/kg and/or a polarization at J2500 in the range of from 1.47 T to 1.57 T and at J5000 in the range of from 1.58 T to 1.65 T, determined in accordance with DIN EN 60404-2.

The non-grain-oriented electrical steel strip or the non-grain-oriented sheet metal preferably has specific core losses at P1.0; 400 Hz in the range of from 8 to 120 W/kg; at P1.5; 400 Hz in the range of from 18 to 360 W/kg; and/or a polarization at J2500 in the range of from 1.45 T to 1.75 T and at J5000 in the range of from 1.45 T to 1.85 T and at J10,000 in the range of from 1.50 and 1.95 T, determined in accordance with DIN EN 60404-2.

In a further specific embodiment, the material has specific core losses at P1.0; 400 Hz in the range of from 10 to 25 W/kg; at P1.5; 400 Hz in the range of from 25 to 49 W/kg; and/or a polarization at J2500 in the range of from 1.45 T to 1.75 T and at J5000 in the range of from 1.45 T to 1.85 T and at J10,000 in the range of from 1.50 and 1.95 T, determined in accordance with DIN EN 60404-2.

The non-grain-oriented electrical steel strip or the non-grain-oriented sheet metal preferably has a yield point in the longitudinal direction under standard normal conditions of from 190 to 610 MPa and a maximum tensile strength of from 310 to 740 MPa and a minimum elongation at break A80 of from 6 to 48%, measured in accordance with DIN EN ISO 6892-1, and a hardness Hv5 of 100-250.

In a more specific embodiment, the material has a yield strength in the longitudinal direction at room temperature of from 310 to 600 MPa and a maximum tensile strength of from 400 to 640 MPa and an elongation at break A80 of from 7 to 32%, measured in accordance with DIN EN ISO 6892-1, and a hardness Hv5 of 130-250.

The material preferably has an anisotropy at P1.0; 400 Hz in the range of from 5 to 17%.

Alternatively, a sheet metal made of a soft magnetic material with the following alloy components can be provided:

Fe, consisting, in addition to Fe and unavoidable impurities, of (all data in wt. %):

0.1-4.0 Si,

0.01-2.60 Al,

0.07-3.0 Mn,

optionally up to 0.5 P,

optionally up to 0.015 B,

optionally up to 0.2 Sb,

optionally up to 0.01 Zn,

optionally up to 5 Cr,

optionally up to 5 Ni,

optionally up to 0.25 V,

optionally up to 0.5 Sn,

optionally up to 0.01 As,

optionally up to 0.3 Nb,

optionally up to 0.5 W,

optionally up to 0.85 Zr,

optionally up to 0.2 Mo,

optionally up to 1.0 Cu,

optionally up to 0.5 Ti,

optionally up to 0.5 C,

optionally up to 0.01 Ce.

Sheet metals, in particular electrical steel strip, with a thickness between 0.05 and 2.5 mm are suitable and can be used, with thicknesses between 0.1 and 1.0 mm being preferred. Thicknesses between 0.15 and 0.4 mm are particularly preferred.

Alternatively, the sheet metal can be a multilayer composite (sandwich) made up of a sheet metal layer, for example made of one of the electrical strips described above, and one or more additional layers, for example with an acoustically damping functional layer (e.g. bondal E). Furthermore, the sheet metal can also be covered on one or both sides with an acoustically damping functional layer (e.g. semi-bondal E), so that the described adhesive system connects directly to the acoustically damping functional layer (e.g. chemical base acrylate). It is known from the art that epoxy resin systems have good compatibility.

Alternatively, the sheet metal can have an acoustically damping functional layer on one side and an adhesive layer to be used according to the present disclosure on the opposite sheet metal side.

Tests have shown that the provision of a sheet metal in accordance with one or more embodiments described herein or one of its further developments in an excellent way allows a joining of sheet metal lamellae carried out with the highest reactivity of the adhesive with the further advantage that suitable methods can be provided with which a production of sheet metal cores is possible also in the linear manufacturing process with a high number of pieces per time. The tests mentioned are given below as examples.

In the case of the sheet metal provided according to one or more embodiments described herein, a particularly advantageous production of sheet metal cores for an electric motor is possible because, according to the knowledge of the developers, a starting material prepared for further processing was provided for the first time that can be used with high economic efficiency both in inline methods, i.e. in methods in continuous processing, as well as in offline methods, i.e. in a method based on baking varnish bonding.

In addition to this particularly advantageous combination of properties, it has surprisingly been found that the sheet metals provided according to the present disclosure are also stable long-term. This means in particular that, in particular in combination with the possibility of inline production of sheet metal core, the sheet metals provided according to the present disclosure meet the basic requirements for integration into typical production processes in the automotive industry, since the long-term stability allows, on the one hand, storage over a longer period of time, at least up to a few weeks, and, due to the temperature stability, also allow processing in the sense of just-in-time delivery, which is typically also carried out in non-tempered trucks in midsummer and must be able to withstand temperatures of at least 40 degrees Celsius over a longer period of time.

Another advantage of the sheet metals provided according to the subject disclosure is that they are mechanically stable, i.e. in particular that the adhesive remains dimensionally stable when pressed compared to adhesives previously used from the baking varnish method mentioned at the outset.

The adhesion is also temperature-stable, as the examples shown below demonstrate. A so-called squeezing out of the adhesive system during pressing does not take place or only takes place to a very reduced extent, in contrast to the conventional baking varnish system.

Through the targeted combination of sheet metal, in a further development of specially selected sheet metal for use in electromobility and specifically selected adhesive compositions, a previously unknown combination of properties is provided, i.e. the possibility of sheet metal cores and electromagnetic components on a large industrial scale, not least for the automotive industry. This provides a person skilled in the art entrusted with the implementation of one or more aspects of the subject disclosure with a flexibility that was previously unknown.

Potential advantages arise, for example, for the electromagnetic, mechanical and thermal machine design, the possibility of choosing a different sheet metal, greater freedom of construction in the lamella design and advantages with regard to possible component tolerances and media and/or heat guidance. Further advantages arise in terms of the component and machine production (for example when handling compact and solid components) and mechanical processing. Further advantages in electric machines with one of the sheet metals according to the present disclosure or one of its developments are higher performance and efficiency, a smaller required installation space, better geometric properties (which can be achieved for example by means of recompression against a stop, in particular with constant surface pressure, with the advantage of better dimensional stability of the electromagnetic component) and, depending on the design, acoustic advantages.

Another aspect of the subject disclosure relates to a method for producing an electromagnetic component. In particular, a sheet metal core for an electric machine, preferably an electric motor, can be provided as the electromagnetic component. The sheet metal core is preferably either a stator core or a rotor core, i.e. it is a stator or a part of a stator or a rotor or a part of a rotor.

The method has the following steps:

A) In a first step, a sheet metal according to the subject disclosure or one of its developments is provided. The sheet metal can be, for example, an electrical steel strip or a printed circuit board separated from a sheet metal strip.

B) The sheet metal is transported to an inline system. The inline system has at least the following stations: a punching tool, means for outputting infrared radiation and an extrusion punch.

The term “inline system” refers to the fact that a number of processing stations, namely at least those mentioned above, are arranged in a predetermined sequence, and a sheet metal, for example an electrical steel strip, fed into the inline system is processed automatically and sequentially at the predetermined stations.

The punching tool is a tool with which one, preferably also more than one, such as four, lamellae are punched out of the sheet metal. In step C), the lamellae are preferably punched using the punching tool in such a way that a number of connecting webs, for example three connecting webs, remain between the relevant punched-out lamella and the sheet metal originally transported in the inline system, so that the punched-out lamella is still an integral part of the sheet metal. This is used to allow further transport of the lamellae together with the sheet metal, in particular the metal strip, through the inline system.

In the above context, the term “lamella” denotes a molded part obtained by cutting it out of the sheet metal, in particular a molded part obtained by punching.

In one alternative, an electromagnetic component, preferably the rotor core, is produced by a conventional stacking process, for example stamped stacking, and a further electromagnetic component, preferably the stator core for the same electrical machine as the conventionally produced stator core, is produced using the method according to the subject disclosure described hereinabove. This can take place, for example, in a combined method or sequentially. Stress relief annealing or recrystallization annealing, optionally additionally a covering step, an activation step and/or an inspection step, can preferably be carried out before the packaging. Activation step in this context means the activation of the adhesive used.

The means for emitting infrared radiation can in particular be designed as an NIR emitter, i.e. a lamp that is designed for emitting electromagnetic radiation in the NIR wavelength spectrum, i.e. with wavelengths between 780 nm and 3 μm.

In one method, the molded parts are illuminated in an NIR wavelength range, with a wavelength between 0.8 micrometers and 1.2 micrometers preferably being used and, particularly preferably, a maximum of the luminous power being achieved with NIR radiation with a wavelength between 0.85 micrometers and 0.9 micrometers. The activation (irradiation) takes place only in the region of the covered surface which is to be available for bonding (is active). The remaining area is screened off with a screen in order to activate only the required region (add picture?). The separation of individual sheet metal cores when the overall height is reached is done by overactivating individual lamellae so that they no longer show any reactivity and thus no longer bond.

Furthermore, as mentioned, the inline system has an extrusion punch. This extrusion punch is a punch which, by applying force perpendicularly to the sheet metal surface, sequentially separates the lamellae which are still connected to the sheet metal, in particular the metal strip, by one or more webs, by separating the web or webs from the sheet metal and preferably, in the same process step, the lamella is conveyed into a receiving device arranged below the sheet metal, in which the lamellae are collected.

Within the inline system, an electrical component, in particular a molded part designed as a stator lamella or a rotor lamella, is punched from the sheet metal provided in step A) with the punching tool, one web or a plurality of webs, in particular three, preferably having a sufficient connection to the sheet metal for the further transport of the molded part.

D) The adhesive covering of the molded part formed in step C) is then illuminated with infrared radiation by means of the means for outputting infrared radiation in order to activate the adhesive covering. In other words, a sufficient temperature for activation is brought about in the sheet metal and in particular the adhesive, for example by illuminating for a period of between 0.5 and 1 second at an emission power between 5 and 10 kilowatts, which is sufficient for an activation temperature between 100 degrees Celsius and 250 degrees Celsius in the adhesive.

The molded part is extruded with the extrusion punch and, preferably in the same movement, the molded part is introduced into a receiving device in which a positioning region is located. The positioning region is used to position and/or angularly align the molded part falling into the positioning region with respect to the molded parts already present there, so that finally a stack of molded parts that are aligned and provided with activated adhesive is obtained.

The positioning region can, for example, be a cylindrical tube, which lies below the conveying plane of the molded part in such a way that, after extrusion, the molded part falls down to an existing stack of molded parts by gravity. The alignment of the molded part takes place through the positioning region, for example designed as a cylindrical hollow tube with a lateral-surface cross section which substantially corresponds to the cross section of the molded parts and is aligned therewith in the intended positioning.

Steps C) to E) are repeated as desired until a desired number of molded parts is in the positioning region and forms a stack of molded parts. The punching tool and the extrusion punch are particularly preferably part of the same press, with the advantage that the punching and extrusion processes are highly synchronized.

The means for outputting the infrared radiation are particularly preferably arranged between the punching tool and the extrusion punch and have at least one upper lamp that is directed in a punching direction onto the first sheet metal surface, one at least one lower lamp that is located on the other side of the sheet metal, on which the punching tool is located, and is directed against a punching direction, or has both at least one upper and at least one lower lamp. The alignment of the lamp on the lamella surface does not necessarily have to be at a right angle, but can also be carried out at a different angle.

In particular in a case in which an upper and a lower lamp are present, an activation of adhesive is possible in a particularly suitable manner both on a first and on the opposite second sheet metal side with the advantageous result that excellent adhesion of the sheet metals to one another can be expected.

According to a one specific method, after the positioning of the last molded part with the desired number of molded parts, the sheet metal core obtained is subsequently compacted. The compaction step is carried out by compacting the sheet metal core in an axial direction of the sheet metal core with a uniform surface pressure on the end face in an axial direction. By means of the compaction, the adhesive bond is produced particularly well between the individual molded parts and thus contributes to the longevity of the sheet metal core. The downstream compaction step preferably takes place outside the press in a downstream compaction station. Alternatively, however, the compaction step can also be carried out by, preferably partial or full, pressure of the extrusion punch in the punching tool.

It can be preferred that steps C) to E) are carried out with a stroke rate of at least 80 per minute, preferably at least 100 per minute, particularly preferably at least 120 per minute and/or up to 1000 per minute, preferably up to 300 per minute, particularly preferably up to 220 per minute. This means that a number of molded parts corresponding to the stroke rate is introduced into the positioning region within one minute.

An alternative method provides that, after providing a sheet metal or a plurality of sheet metals, preferably an electrical steel strip, a number of molded parts from the sheet metal provided in step A) is punched in the punching tool in a step B), whereafter a positionally aligned and/or angularly aligned superimposing of the molded parts is carried out and these molded parts are pressed in a separate station, which can be designed as an oven, for example, and heated for a predetermined period of time to a predetermined temperature or to temperatures in a predetermined temperature range. This procedure is quite similar to the procedure known from the baking varnish method explained at the outset, but differs in the starting material used, which is specifically one of the materials mentioned at the outset. Only with the materials mentioned at the outset is it possible on the one hand to be able to achieve a long storage time and at the same time to be able to achieve the provision of sheet metal cores with a specific number of finished sheet metal packages per time, so that, as a result, good use of the method in mass production can be expected.

The predetermined period of time is preferably between 10 minutes and 60 minutes, particularly preferably between 10 minutes and 40 minutes. In the case of the initially mentioned sheet metals used according to the subject disclosure, this period of time is completely sufficient to obtain finished sheet metal cores. The predetermined temperature is particularly preferably between 100 degrees Celsius and 200 degrees Celsius, in particular between 100 degrees Celsius and 150 degrees Celsius. In laboratory tests, for example, samples could be successfully produced with a specified temperature of 120 degrees Celsius and a specified period of 30 minutes. This example also shows one of the advantages of the method according to the subject disclosure compared to a conventional baking varnish method, in which both higher temperatures and longer periods of time are common, for example annealing at 190 degrees Celsius for a period of 60 minutes. The reason is that it has been possible to provide a sheet metal with an adhesive that is significantly more reactive than previously used adhesives. The major influence on the bonding parameters (time/pressure and temperature) required in practice is specifically dependent on the geometry at hand since, for example, a core temperature that is set in the component has an influence on the course of the bonding method.

The edges of a sheet metal core may be cleaned following the methods for producing said core in order to remove any adhesive residues on an edge or side of the sheet metal core. The cleaning can be done chemically and/or mechanically.

In order to increase the strength of the adhesive layer, provision can be made to arrange inorganic and/or organic fibers in the adhesive covering.

### EXAMPLES

Examples of a sheet metal according to the subject disclosure and its advantageous behavior for the method according to the subject disclosure result from tests carried out.

The following samples were produced:

Printed circuit board made from electrical steel strip M800-50A (according to EN 10027-1) with the material code 1.0816 (according to EN 10027-2), thickness 0.5 mm, length×width: 200×150 mm.

Samples 0, 1, 2 and 3 were made. Samples 0, 1 and 2 are comparative samples, they are covered with an adhesive not according to the subject disclosure.

Sample 3 is a sample according to the present disclosure.

The samples produced are printed circuit boards of the type mentioned above, which have been covered with adhesive using an application roller according to the following parameters:

| | wt. | | | |
|---|---|---|---|---|
| | parts of | wt. | | |
| | epoxy resin | parts of | wt. | |
| Sample | (present as | curing | parts of | Selected |
| designation | solid resin) | agent | accelerator | accelerator |
| Sample 0 | 60 | 3.5 | 4.5 | Conventional |
| | | | | accelerator |
| | | | | (DYHARD |
| | | | | URAcc57, brand |
| | | | | name) |
| Sample 1 | 60 | 3.5 | 3.0 | Conventional |
| | | | | accelerator |
| | | | | (DYHARD |
| | | | | URAcc13, brand |
| | | | | name) |
| Sample 2 | 60 | 3.5 | 3.0 | Conventional |
| | | | | accelerator |
| | | | | (DYHARD |
| | | | | URAcc13, brand |
| | | | | name) |
| Sample 3 | 60 | 3.5 | 3.0 | 4,4′-methylene- |
| | | | | bis- |
| | | | | (phenyldimethyl |
| | | | | urea) |

Layer thicknesses

Sample 0: 1st surface: 6 μ, 2nd surface 0 μm,

Sample 1: 1st surface: 6 μm, 2nd surface 0 μm,

Sample 2: 1st surface: 4 μm, 2nd surface 2 μm,

Sample 3: 1st surface: 4 μm, 2nd surface 2 μm.

A plurality of specimens were made of each of the sample types. To test the long-term stability, 18 sandwich structures were made of two identical samples.

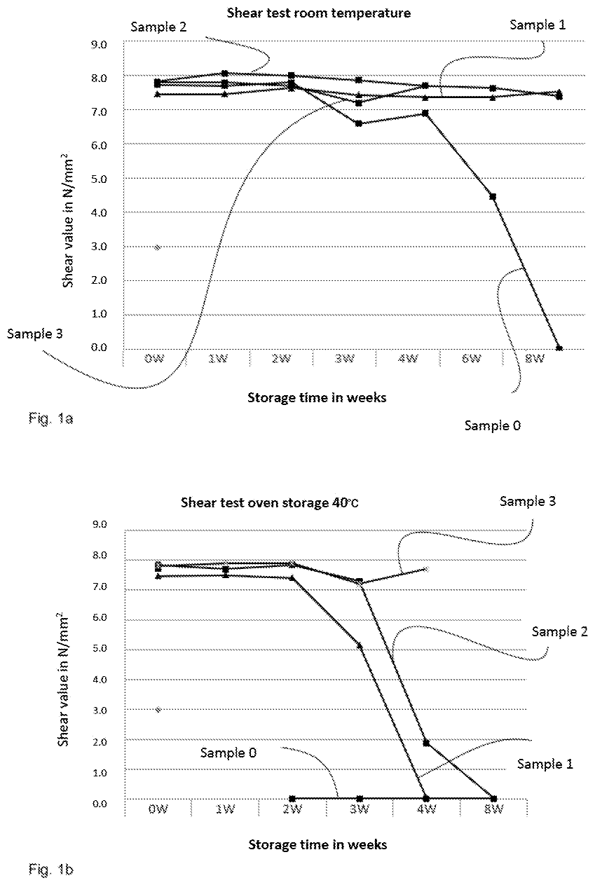

Two samples of the same type were bonded using a plate press with a plate area of 200 mm×200 mm with a surface pressure of 3 N/mm², the adhesive being activated in an oven by heating to 120° C. and holding at 120° C. for 30 minutes. Then 8 samples were placed in an oven and stored there at 40° C. A sample was taken every week and a shear value test was performed (based on DIN EN 1465). In addition, a shear value test was performed every week on specimens stored at room temperature. The results of the test are shown in FIG. 1a and 1b.

It can be seen from the results that, at room temperature, the composition used according to the subject disclosure has better shear values than the reference samples sample 0, sample 1 and sample 2. Sample 0 tested after six weeks had a significantly reduced shear value; after 8 weeks, sample 0 had a shear value of 0.

Storage at 40 degrees Celsius results in a shear value of 0 for the reference sample 0 after one week at the latest, i.e. the sample has no storage stability at 40 degrees Celsius. After 2 weeks, sample 1 and sample 2 had an almost unchanged good shear value of over 7.0 N/mm², but began to degrade noticeably after three weeks of storage.

In all cases, the shear value of sample 2 with a surface covered on both sides is higher than the shear value of sample 1 with a surface covered on one side.

In particular, it can be seen that sample 3 has the best storage stability with an almost unchanged good shear value after 4 weeks at 40 degrees Celsius storage. The only sample that could be obtained was a printed circuit board sandwich which, even after four weeks of storage at 40 degrees Celsius, still had an unchanged good shear value. At the time of application, the tests were still ongoing.

In addition, tests were carried out on the finished sandwiches, they were heated to test temperatures, then, after briefly holding them under heat, also subjected to a shear value test.

| Shear values | | | | |
|---|---|---|---|---|
| [N/mm²] | Sample number | | | |
| mean value | Sample 2 | | Sample 3 | |
| from 3-fold test | | Standard | | Standard |
| in each case | [N/mm²] | dev. | [N/mm²] | dev. |
| RT | 5.55 | 0.88 | 6.01 | 0.26 |
| 50° C. | 5.08 | 1.32 | 5.85 | 0.11 |
| 100° C. | 5.38 | 0.27 | 5.59 | 0.12 |
| 150° C. | 4.89 | 0.42 | 5.22 | 0.08 |
| 200° C. | 4.66 | 0.46 | 4.96 | 0.04 |

The results show that both sample 2 and sample 3 can withstand high temperatures of up to 200° C. over a certain period of time without losing their mechanical stability. In particular, it can be seen that the shear values of sample 3 are significantly higher than those of comparison sample 2.

Sample 0 was subjected to the temperature test as a reference, it was shown that a shear value of about 0.90 N/mm² was obtained after heating to 150° C. On the basis of sample 3, it was thus found that the sheet metals according to the subject disclosure are suitable for the production of more temperature-stable sheet metal cores compared to sheet metals that are already known.

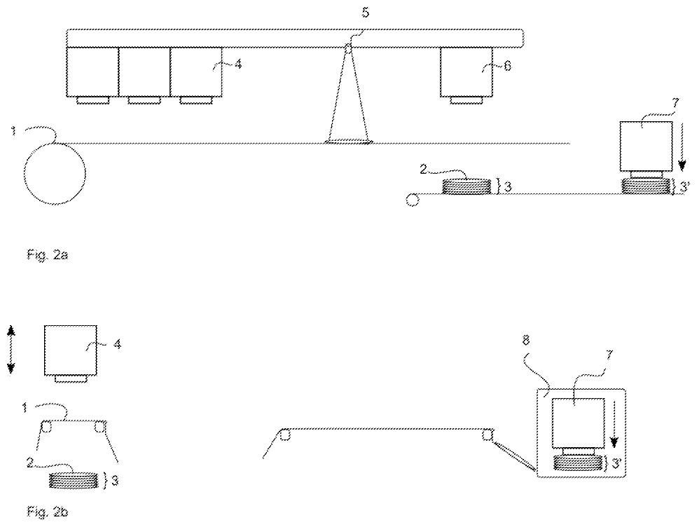

An example of a first embodiment of the method for producing a sheet metal core for an electric motor is shown in FIG. 2a. A sheet metal already covered with a plastics material is provided, in particular as a non-grain-oriented electrical steel strip 1. This is transported into an inline system. In a first station, a number of extrusion punches 4 ensures that molded parts 2, which are designed as rotor lamella or stator lamella, are extruded. In a subsequent station, the molded part is illuminated by means of a means designed as an NIR emitter for outputting infrared radiation 5, and the resulting heating activates the adhesive covering of the molded part. The molded part is then extruded with the extrusion punch 6 and collected in a positioning region to form a stack 3 in a position-oriented and/or angular manner. Finally, in a compaction station, compaction with a compaction ram 7 takes place until the adhesive has cured and the finished sheet metal core can be removed.

FIG. 2b is a manufacturing process which is similar to the known baking varnish process. The method of FIG. 2b differs from the method of FIG. 2a in particular in that the molded parts 2 are extruded and the stack 3 is formed before the adhesive covering is activated. The adhesive is only finally activated in an oven 8, for example at a temperature between 100 and 200 degrees Celsius, with the sample being compacted by means of a stamp 7 at the same time.

It will be appreciated that various implementations of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. Sheet metal for producing an electromagnetic component, in particular a stator core or a rotor core, wherein the sheet metal is covered with an adhesive covering of a thermally activated adhesive, wherein the adhesive contains:
60 wt. parts of an epoxy resin in solid resin form,
0.5-15 wt. parts of a latent curing agent,
1-15 wt. parts of a latent accelerator.

2. Sheet metal according to claim 1, wherein the adhesive contains:
1 to 10 wt. parts of a latent curing agent.

3. Sheet metal according to claim 1, wherein the epoxy resin is bisphenol A epoxy resin.

4. Sheet metal according to claim 1, wherein the latent curing agent contains a dicyandiamide, an imidazole, a BF3 amine complex or a combination thereof.

5. Sheet metal according to claim 1, wherein the adhesive contains:
1 to 10 wt. parts of a latent accelerator,

6. Sheet metal according to claim 1, wherein the adhesive furthermore has 0.2 to 8 wt. parts of absorption additives, selected from the group of lamp blacks and/or from the group of water-soluble dyes.

7. Sheet metal according to claim 1, wherein the latent accelerator contains a urea derivative.

8. Sheet metal according to claim 7, wherein the urea derivative is an N,N-dimethylurea or an N,N′-dimethylurea or a bifunctional urea derivative.

9. Sheet metal according to either claim 7, wherein an asymmetrically substituted urea is also or exclusively used as the urea derivative.

10. Sheet metal according to claim 1, wherein the urea derivative is a substance 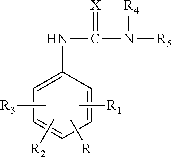
where R: hydrogen or a group according to 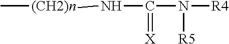
where
n=0 or 1,
X=O or S,
R1, R2 and R3: each hydrogen, a halogen, nitro group, a substituted or unsubstituted alkyl group, alkoxyl group, aryl group or aryloxyl group,
R4: alkyl group, alkenyl group, cycloalkyl group, cycloalkenyl group, aralkyl group optionally substituted by a halogen, hydroxyl or cyano,
R5: like R4 or alkoxyl group, R5 optionally forming a heterocyclic ring with R4, or an N,N-dimethyl-N′-(3,4-dichlorophenyl)urea or an N,N-dimethyl-N′-(3-chloro-4-methylphenyl)urea or an N,N-dimethyl-N′-(3-chloro-4-methoxyphenyl)urea or an N,N-dimethyl-N′(3-chloro-4-ethylphenyl)urea or an N, N-dimethyl-N′-(4-methyl-3-nitrophenyl)urea or an N-(N′-3,4-dichlorophenylcarbamoyl)morpholine or an N,N-dimethyl-N′(3-chloro-4-methylphenyl)thio-urea,
the urea derivative is optionally 4,4′ methylene-bis-(phenyldimethylurea);
or a mixture of two, three or more of the aforementioned.

11. Sheet metal according to claim 7, wherein the particles of the urea derivative have an average particle size between 1 μm and 30 μm.

12. Sheet metal according to claim 1, wherein the adhesive covering is applied to one or both sides of the sheet metal and has a thickness between 1 μm and 20 μm.

13. Sheet metal according to claim 12, wherein the adhesive covering consists of a first partial covering of the first sheet metal surface with a first thickness and a second partial covering of the second sheet metal surface with a second thickness, the first thickness preferably being at least 1.5 times, particularly preferably double the second thickness.

14. Sheet metal according to claim 1, wherein an insulating varnish layer is arranged between the sheet metal and the adhesive layer and/or only insulating varnish is arranged on the side opposite the adhesive layer.

15. Sheet metal according to claim 1, wherein the sheet metal is an electrical steel strip, in particular a non-grain-oriented electrical steel strip, or has been separated from a non-grain-oriented electrical steel strip.

16. Sheet metal according to claim 15, consisting, in addition to Fe and unavoidable impurities, of (all data in wt. %):
0.1-3.50 Si,
0.01-1.60 Al,
0.07-0.65 Mn,
optionally up to 0.25 P.

17. Sheet metal according to claim 1, wherein the sheet metal is a soft magnetic, metallic material, for example
consisting, in addition to Fe and unavoidable
impurities, of (all data in wt. %):
0.1-4.0 Si,
0.01-2.60 Al,
0.07-3.0 Mn,
optionally up to 0.5 P,
optionally up to 0.015 B,
optionally up to 0.2 Sb,
optionally up to 0.01 Zn,
optionally up to 5 Cr,
optionally up to 5 Ni,
optionally up to 0.25 V,
optionally up to 0.5 Sn,
optionally up to 0.01 As,
optionally up to 0.3 Nb,
optionally up to 0.5 W,
optionally up to 0.85 Zr,
optionally up to 0.2 Mo,
optionally up to 1.0 Cu,
optionally up to 0.5 Ti,
optionally up to 0.5 C,
optionally up to 0.01 Ce.

18. Sheet metal according to claim 15, having a thickness between 0.05 mm and 2.5 mm plus an adhesive covering.

19. Sheet metal according to claim 16, wherein the sheet metal is a sandwich or a sheet metal covered on one or both sides with an acoustically damping functional layer.

20. Method for producing an electromagnetic component, in particular a sheet metal core for an electrical machine, comprising the following steps:
A) providing a sheet metal provided with an adhesive covering or a plurality of sheet metals provided with an adhesive covering according to claim 1,
B) transporting the sheet metal into an inline system, comprising: a punching tool, means for outputting infrared radiation and an extrusion punch,
C) punching a molded part designed as a stator lamella or as a rotor lamella from the sheet metal provided in step A with the punching tool,
D) illuminating the adhesive covering of the molded part formed in step C with infrared radiation by means of the means for outputting infrared radiation to activate the adhesive covering of the molded part,
D) extruding the molded part with the extrusion punch,
E) positionally aligned and/or angularly aligned positioning of the molded part in a positioning region,
F) repeating steps C) to E) until a desired number of molded parts has been reached in the positioning region.

21. Method according to claim 20, wherein the production of the component takes place in an inline process, the punching tool and the extrusion punch being part of the same press.

22. Method according to claim 20, wherein the means for outputting infrared radiation are arranged between the punching tool and the extrusion punch and have:
at least one upper lamp which is directed in a punching direction onto a first molded part surface or
at least one lower lamp which is directed against a punching direction onto a second molded part surface present on the other side of the punching tool or
both at least one upper and at least one lower lamp.

23. Method according to claim 20, wherein after positioning the last molded part of the desired number of molded parts, the component obtained by means of a compaction step downstream of step F is compacted with an even surface pressure at the end.

24. Method according to claim 20, wherein steps C to E are carried out with a stroke rate of at least 80 /min.

25. Method for producing an electromagnetic component, in particular a sheet metal core for an electrical machine, comprising the following steps:
A) providing a sheet metal provided with an adhesive covering or a plurality of sheet metals provided with an adhesive covering according to claim 1,
B) punching a number of lamellae, in particular molded parts designed as stator lamellae or as rotor lamellae, from the sheet metal provided in step A with the punching tool,
C) superimposing the molded parts in a positionally aligned and/or angularly aligned manner,
D) pressing the superimposed molded parts,
E) heating the superimposed molded parts for a predetermined period of time at a predetermined temperature,
F) optionally, after positioning the last molded part of the desired number of molded parts, compacting the component obtained by means of a compaction step downstream of step E with an even surface pressure at the end in a direction perpendicular to the molded part surface.

26. Method according to claim 25, wherein the predetermined period of time is between 10 minutes and 60 minutes.

27. Method according to claim 25, wherein the predetermined temperature is between 100° C. and 200° C.

28.-32. (canceled)
